(19) United States
(12) Patent Application Publication
(10) Pub. No.: US 2007/0221758 A1
(43) Pub. Date: Sep. 27, 2007

(54) Precision irrigator apparatus, system and method

(76) Inventor: Haion Won, Basking Ridge, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/387,262

(22) Filed: Mar. 23, 2006

(51) Int. Cl. B05B 1/26

(52) U.S. Cl. 239/515; 239/504; 239/505; 239/508; 239/513

(57) ABSTRACT

A precision irrigator system and process comprises a reflector plate having a center and an outer perimeter. The reflector plate is composed of a malleable material that can be contoured by a user to compensate for irregularities in the land area to be irrigated. At least one attachment means is secured to the reflector plate. The attachment means is adapted to connect the reflector plate to an irrigator or sprinkler system that operates to provide water to terrain having the irregular areas. By contouring and adjusting the reflector plate, the user can accommodate changes in the vegetative area's lawn shape or irregular lawn portions. The reflector plate is readily adjusted by the user so that water from the sprinkler comes into intimate contact with the outer perimeter of the reflector plate, and is deflected onto the ground. Bending or otherwise adjusting the reflector plate brings varied amounts of water from the sprinkler into contact therewith, deflecting the water into the vegetative area. Water distribution from the sprinkler can be thereby correlated with the irregular shape of a vegetative area, conserving the water supplied, and assuring that irrigation proceeds economically in an accurate, reliable manner.

### BACKGROUND OF THE INVENTION

1. Field Of The Invention

The present invention relates to a precision irrigator apparatus, system, and process; and more particularly, to an irrigator apparatus and system which, when attached to a typical irrigator can be adjusted and configured to facilitate irrigation of irregular lawn sizes, or variably sized and shaped gardens, thereby conserving water and avoiding irrigation of unwanted areas.

2. Description Of The Prior Art

Irrigation systems, typically of the oscillating sprinkler genre, are commonly utilized when delivering water to vegetative areas, such as gardens, fields, and lawns for commercial, agricultural, and residential needs. Frequently, these vegetative or irrigation areas have irregular terrain shapes, thereby making it difficult to efficiently water the entire area without causing watering to occur in adjoining areas such as sidewalks, driveways, patios and the like. The inadvertent wetting down of these non-vegetative areas adjacent lawn and garden portions appointed for irrigation is annoying, and wastes valuable water resources. Where the shape of the area includes varying distances or radii from a substantially centrally located sprinkler, such as a short radius d₁ and a long radius d₂, water delivery distance adjustments must be made to accommodate the differing radii. Optimization of water delivery to d₁ would necessarily result in insufficient water delivery to the greater d₂ distance causing vegetation in the outer boundaries of d₂ to receive insufficient water for optimal growth. On the other hand, optimization of water delivery to d₂ would necessarily result in excessive water delivery to the shorter d₁ distance causing water encroachment, and even saturation, in areas that are not intended to be watered, thereby wasting water and, occasionally, causing neighboring objects to incur water damage.

Various types of adjustable sprinkler systems have been proposed to address irrigation problems associated with irregularly shaped irrigation areas. However, none of these adjustable sprinkler systems accommodate irrigation of irregularly shaped areas means of a simple, economical, mechanically adjustable mechanism. Instead, many of the previously proposed sprinkler systems involve integral automated adjustment measures appointed to provide water delivery at differing radii by water flow rate control, angularization of the sprinkler's nozzle, and the like. Such water delivery devices are integrally constructed within the sprinkler. They require programmable means or other adjustment measures that increase manufacturing costs and decrease operating reliability.

U.S. Pat. No. 6,079,637 to Ohayon discloses an automatic adjustable sprinkler for precision irrigation having a base, an inlet disposed therein for receiving irrigating liquid from a source, and a nozzle rotatably coupled to the base about a central axis. The sprinkler further includes an adjustable valve for controlling a flow rate of the irrigating liquid through the nozzle, and a plate rotatably coupled to the nozzle. The disclosed plate includes a cam surface having a contour which corresponds with the shape of the area and which engages with a cam-engaging element. In turn, the cam-engaging element engages with a lever element being operatively coupled to the valve so that the contour of the cam surface causes the valve to control the flow rate of the irrigating liquid. The disclosed device functions to control the flow rate of the irrigating liquid and acts as an integral component of the system, interstitially located in the sprinkler unit. The device does not function to reflect water at varying radii from the sprinkler.

U.S. Pat. No. 4,613,077 to Aronson discloses a programmable sprinkler wherein water volume and projecting force are controlled in order to irrigate irregular lawn areas. The programmable sprinkler generally includes a sprinkler having a relatable head having nozzle means for directing a fluid stream, drive means, control valve means for varying the flow of fluid to the nozzle means, and co-acting control means for controlling the control valve means. The control means includes a plate-like cam, mounted on the body of the sprinkler, having a peripheral edge cam surface which includes the control valve means that varies fluid flow. The device does not provide a reflective plate for reflecting water at controlled radii. Instead, the disclosed device provides an integrated programmable sprinkler that allows the user to control the water volume and projection force in order to provide a controlled delivery to irregular lawns. There is a direct correlation between the water volume and projection force. A lower water volume produces less projection force causing smaller radii areas to be watered. The device does not variably reflect water to control its delivery to irregular areas.

U.S. Pat. No. 4,479,611 to Galvis discloses a pop-up sprinkler provided with a control valve for sealing a sprinkler housing against water inflow. When the pressure in a water supply line reaches or exceeds a predetermined level, a spring-biased pop-up stem moves to an elevated spraying position. The device does not provide a reflective plate for reflecting water at controlled radii. Instead, the disclosed device provides a pop-up stem which responds to predetermined levels of water pressure, so that when the predetermined level is great, a large force of water is applied and the pop-up stem is elevated; thereby delivering water to a larger radius or distance. Conversely, when the predetermined water pressure is low, the pop-up stem is only slightly elevated; thereby delivering water to a shorter radius. The device does not provide for reflective delivery of water to control water delivery to irregular areas.

U.S. Pat. No. 3,952,954 to Taylor discloses an automatic sprinkler apparatus for watering irregular areas. The apparatus comprises a programmer, speed control means, and a nozzle having an adjustable angle of elevation arranged for rotation about a base. The angle of elevation of the nozzle, or the trajectory of the water spray, is adjusted to control the radial distance the water travels therefrom. Speed control means and the angle of the water leaving the nozzle are adjusted by a sensor so that time and distance of water flow from the apparatus to a finite area is kept constant. The device does not provide means for reflective delivery of water at controlled radii. Instead, the delivery of water is based upon programmed time and distance parameters, on which basis the nozzle's angle of elevation and water delivery speed is adjusted. The device does not provide for reflective delivery of water to control irrigation of irregular areas.

U.S. Pat. No. 4,760,959 to Gorney discloses a drive arm deflector for a rotary impact sprinkler. The deflector comprises a generally elongated arm that is fixedly mounted onto the body of the sprinkler. The deflector defines a spiral water engagement surface, which extends approximately 360 degrees from an inlet location intermittently adjacent the sprinkler nozzle to an outlet location. The deflector is attached to the sprinkler nozzle. It provides a spiraled water engagement surface through which water travels and streams into the irrigation area. A cover member is attached to the sprinkler to protect it when the sprinkler is retracted within its housing. The cover member does not come into contact with the water stream, and it cannot be adjusted by a user to compensate changes in radii in a lawn area. The disclosed device is integrally constructed within the sprinkler. It is attached to the sprinkler nozzle in order to provide a spiral pathway for water to travel upon. The cover member is designed to protect the sprinkler when it is retracted within its housing. It is not malleable, and is not adjusted manually to provide a rigid surface against which water reflects at radii desired for delivery to a preselected location.

Conventional sprinkle device covers are utilized to protect the sprinkler and prevent damage that can result when machinery and the like roll over the sprinkler mechanism. These devices do not affect the delivery of water, but merely provide a protective covering for the sprinkler. For example, U.S. Pat. No. 5,931,385 to Miller discloses a dome shaped disk appointed for covering a sprinkler head in order to protect the sprinkler from damage that can occur as heavy objects, such as autos or equipment, roll over the sprinkler. The disclosed cover generally comprises a single molded piece forming a circular disk having a dome shaped upper surface and a flat bottom surface. A central aperture is provided within the disk so that the disk can be placed upon the surface of the ground. At least three conically shaped posts, attached to the bottom surface of the disk, securely anchor the cover to the ground. The central aperture has a diameter sufficient to allow the sprinkler head to penetrate the cover and freely spray the intended region. The disk cannot be adjusted to reflect water from the sprinkler. Rather, it must be rigid to provide protection to the sprinkler mechanism. Moreover, the disk does not interrupt or reflect water to control its delivery to irregular lawn areas. Rather, its construction facilitates an uninterrupted water spray to freely penetrate unwanted areas contiguous to the region appointed for irrigation.

Even where reflective means is utilized to accomplish adjustment of water delivery conventional sprinkler systems, the adjustment is not effected by a malleable reflective plate that is readily attached to a conventional sprinkler. U.S. Pat. No. 5,267,689 to Forer discloses a rotary sprinkler head having individually adjustable deflector plates hingedly mounted to the underside of a deflector cap. A thin annular sheet of material is attached to the deflector plates to provide water stream delivery. The deflector plates are adjusted, by way of a screw, thereby altering the path of a water stream from a rotating nozzle assembly as it passes each of the deflector plates in turn. The rotary sprinkler head has individually adjustable deflector plates, which are integrally associated with the sprinkler. Adjustment, achieved by adjusting each individual plate, is a laborious, time-consuming process. Moreover, the plurality of plates and arrangement of the adjustment means associated therewith, increase the size and weight of the irrigation product.

Notwithstanding the efforts of prior art workers to construct an irrigation apparatus, system, and process capable of delivering liquid to vegetative areas, there remains a need in the art for a precision irrigation system having a reflector plate that can be easily bent and thereby adjusted to accommodate irregularities in the irrigation area with minimal effort. In addition, there is a need in the art for a precision irrigation system that is easy to install and use, and that can retrofit conventional sprinkler systems, or be manufactured and sold with new sprinklers. Such a simple, economical, precision irrigation system and process, wherein a flexible reflective plate is readily attached to a sprinkler and adjusted by bending to deflect a water stream, thereby effecting accurate and efficient irrigation of an irregularly shaped area has long been needed in the art.

### SUMMARY OF THE INVENTION

The present invention provides an irrigation apparatus, system, and process capable of delivering liquid to vegetative areas. The system comprises a flexible, reflector plate that can easily bent and thereby adjusted to accommodate irregularities in an irrigation area with minimal effort. Advantageously, the system is easy to install and use. It can retrofit conventional sprinkler systems, or be manufactured and sold with new sprinklers. The flexible reflective plate is readily attached to a sprinkler and adjusted by bending to deflect a water stream, thereby effecting accurate and efficient irrigation of an irregularly shaped area.

More specifically, the invention provides a precision irrigator apparatus comprising a flexible reflector plate that is easily bent or contoured to vary the radii of a water stream deflected therefrom, and hence the distribution pattern of the stream over an area appointed for irrigation. Variation of the water stream radii is readily correlated with the shape of a lawn, garden or other area to be irrigated. By contouring and adjusting the reflector plate the user can accommodate changes in the vegetative area's shape. The flexible reflector plate construction affords a cost effective, efficient way to direct water spray from a sprinkler, so that different radii can be achieved and there is greater control over the water delivery locus.

An economical, lightweight irrigator system for accurately and reliably delivering water to irregular areas is thereby provided. Generally stated, the irrigator system comprises a reflector plate that is substantially composed of a malleable material so that the reflector plate can be adjusted by a user. The reflector plate includes a center and an outer perimeter. At least one attachment means is provided, for attaching the reflector plate to an irrigator. The irrigator is of the conventional variety, which provides water to a vegetative area. The reflector plate is attached to the irrigator by way of the attachment means. When associated with the irrigator, the reflector plate can be adjusted by the user so that the water delivery is correlated with the shape of the vegetative area. The correlation is such that water falls essentially within an irregularly shaped area. Water is conserved and irrigation proceeds in an accurate, economical manner.

Also provided is an irrigator system for watering irregular areas that includes a sprinkler and reflector plate substantially composed of a malleable material. The malleable material provides flexibility to the reflector plate so that the reflector plate can be adjusted by a user. Such adjustment is generally achieved by bending or contouring the reflector plate based upon the irregular shaped area's dimensions. The reflector plate has a center and an outer perimeter. It is attached to the sprinkler of the conventional kind, which is capable of providing water to a vegetative area. The reflector plate attached to the sprinkler is adjusted by the user so that water emanating from the irrigator nozzle is deflected by the altered contour of the plate, causing its distribution over the vegetative area in a pattern which conforms essentially with the shape thereof. That is to say, water is distributed from the irrigator with such precision that its distribution pattern is correlated with the shape of the irregular area, causing the water to predominantly land therewithin.

In addition, the invention provides a method for irrigating irregularly shaped vegetative areas, comprising the step of attaching a reflector plate to an irrigator. The irrigator is appointed to provide water to terrain having irregular shaped vegetative areas. The reflector plate is substantially composed of a malleable material so that the reflector plate can be adjusted by a user. In addition, the reflector plate has a center and having an outer perimeter. After the reflector plate is attached to the irrigator, it is bent or otherwise adjusted by the user, to bring select portions of the plate into contact with the water stream. This variable contact of the water stream with select portions of the reflector plate operates to variably deflect the water stream emanating from the irrigator, so that water delivery is correlated with the shape of the vegetative area.

### BRIEF DESCRIPTION OF THE DRAWING

The invention will be more fully understood and further advantages will become apparent when reference is had to the following detailed description of the preferred embodiments of the invention and the accompanying drawings, in which:

FIG. 1a illustrates a schematic top view of the reflector plate of the precision irrigation apparatus and system, wherein the irrigation apparatus is not attached to a sprinkler system;

FIG. 1b illustrates a side view of the reflector plate of the precision irrigation apparatus and system shown in FIG. 1a taken along line V, wherein the irrigation apparatus is not attached to a sprinkler system;

FIG. 2a illustrates a schematic top view of another embodiment of the reflector plate of the precision irrigation apparatus and system, wherein the irrigation apparatus is not attached to a sprinkler system;

FIG. 2a illustrates a side view of the embodiment of the reflector plate of the precision irrigation apparatus and system shown in FIG. 2a taken along line X, wherein the irrigation apparatus is not attached to a sprinkler system;

FIG. 3 illustrates the precision irrigation apparatus, system, and process in an adjusted configuration adapted to precisely water an irregularly shaped vegetative area;

FIG. 4 illustrates the precision irrigation apparatus, system, and process adjusted in configuration adapted to precisely water an irregularly shaped vegetative area;

FIG. 5 illustrates schematic views of the reflector plate, showing the plate having various shapes, and further illustrating placement of at least one attachment means;

FIG. 6a illustrates a schematic top view of another embodiment of the reflector plate of the precision irrigation apparatus and system wherein there is a single attachment means;

FIG. 6b illustrates a side view of the reflector plate of the precision irrigation apparatus and system shown in FIG. 6a taken along line XX, further showing the apparatus with a single attachment means;

FIG. 7 illustrates a schematic top view of another embodiment of the reflector plate of the precision irrigation apparatus and system wherein there are dual attachment means located in proximity to one another; and

FIG. 8 illustrates a schematic top view of another embodiment of the precision irrigation apparatus and system wherein there is a single attachment means and the apparatus is fixed within a manufactured sprinkler.

### DETAILED DESCRIPTION OF THE INVENTION

The present invention relates to an irrigator system and a process for watering irregular areas. The irrigator system can be readily attached to an existing sprinkler. Alternatively, the irrigator system and process can be manufactured with a sprinkler. The irrigator system and process comprises a flexible reflector plate that is readily adjusted, by bending or otherwise, so that adjusted radii are achieved. These adjusted radii can be correlated changes in lawn shape or irregular lawn portions. This flexible reflector plate construction provides a cost effective, efficient way to direct water spray from a sprinkler. Advantageously, the different radii obtained to provide increased control the distribution pattern of water delivered from the sprinkler.

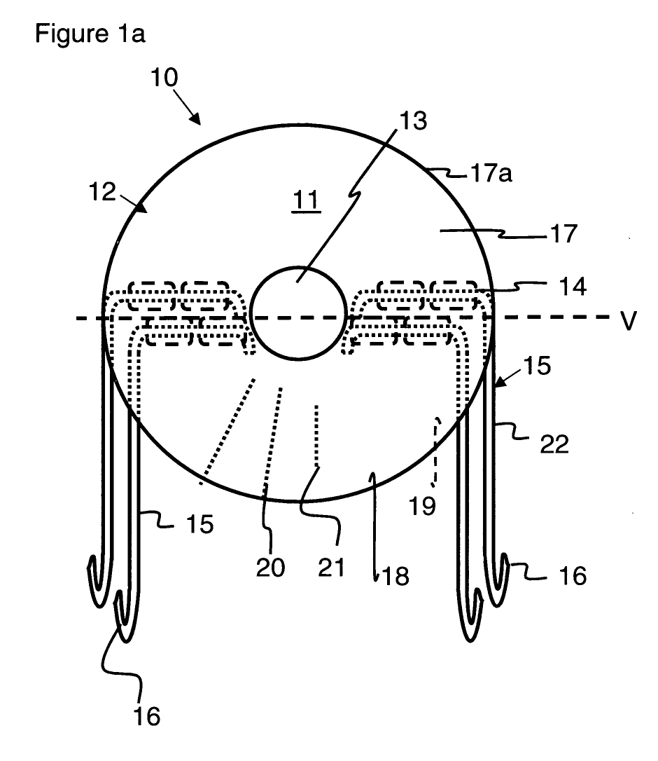

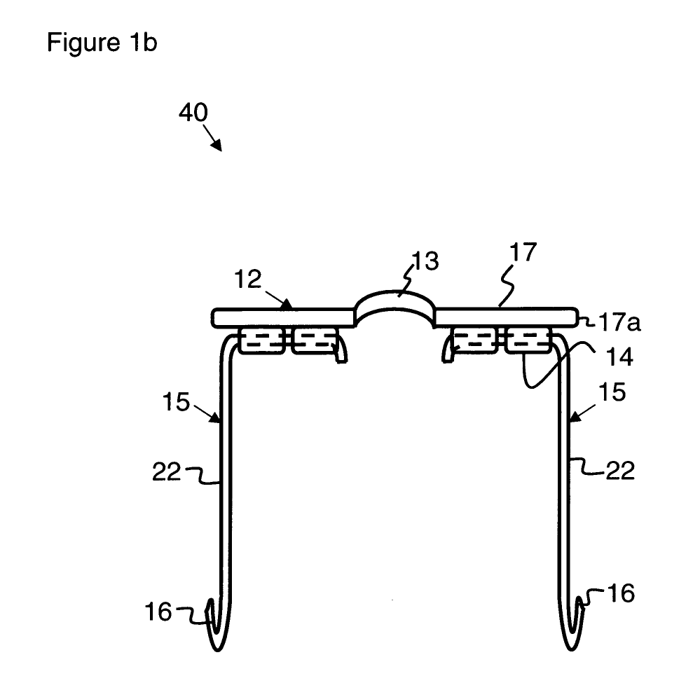

FIG. 1a illustrates a schematic top view of the reflector plate associated with the irrigation apparatus and system. In this view of the sprinkler system, shown generally at 10, the irrigation apparatus is not attached directly to the sprinkler. A side view of the reflector plate, taken along plane V of the precision irrigation apparatus 11 is illustrated in FIG. 1b, shown generally at 40. As illustrated in FIGS. 1a and 1b, the precision irrigation apparatus 11 comprises a reflector plate 12 appointed to be attached to an irrigator, such as a sprinkler, for watering vegetative areas, namely lawns, gardens, fields for residential, agricultural, and commercial endeavors. Reflector plate 12 is substantially composed of a malleable material, such as an aluminum material, so that the reflector plate 12 can readily be adjusted or contoured by a user. Reflector plate 12 is adjusted or contoured by the user so that water is delivered to varying radii in the irregular areas of the terrain.

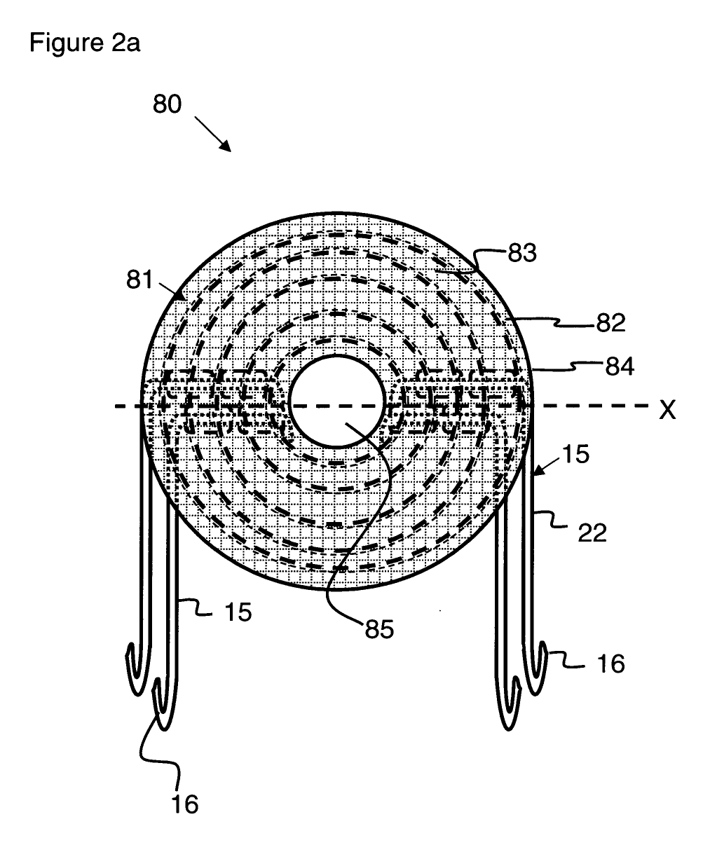

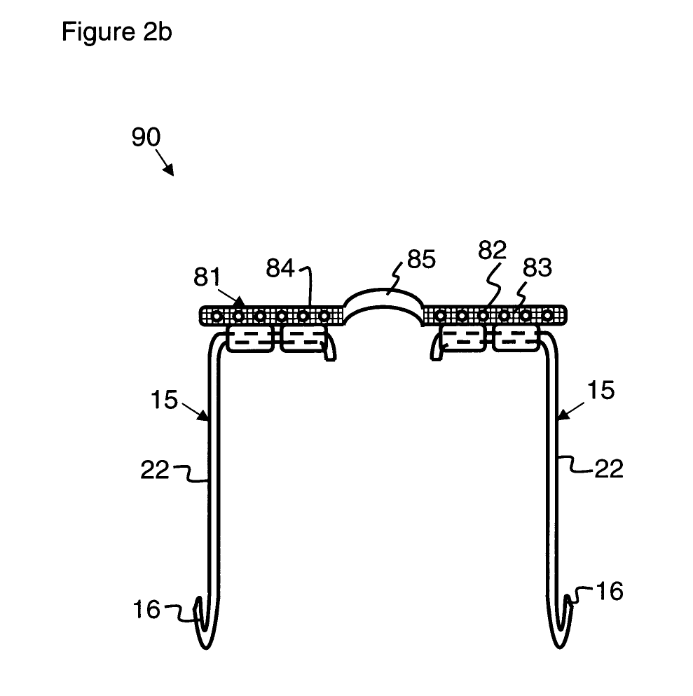

The reflector plate 12 includes center 13, outer perimeter 17, top surface 18 (external), and bottom surface 19 (internal). Outer perimeter 17 includes outer rim 17a. Optionally, the bottom or internal surface 19 of the reflector plate 12 is coated with a thin film, preferably polymeric in composition. This thin film acts as a buffer in order to decrease the sound levels from advancing to high decibels as the water being forcefully ejected from the sprinkler comes into contact with the reflector plate 12. Alternatively, the reflector plate 12 is composed of an internal flexible portion and an external flexible covering so that the reflector plate 12 is readily adjustable (see FIG. 2). Optionally, the center 13 of the reflector plate 12 may be composed of a rigid material in order to provide greater stability and staying power to the outer perimeter 17 as the outer perimeter 17 is contoured and adjusted by the user. Alternatively, the center 13 comprises an aperture or hole so that the user has access to the irrigator or sprinkler (not shown in FIG. 1) when the reflector plate 12 is attached to the sprinkler.

Continuing with FIG. 1, the precision irrigator apparatus 11 and system may include a plurality of perforations 20 located interstitially within the reflector plate 12. These perforations 20 preferably extend throughout the outer perimeter 17 to the outer rim 17a of the reflector plate 12. These perforations 20 function to facilitate the user when adjusting or contouring the reflector plate 12 so that the reflector plate 12 is readily adjusted by the user with ease. Alternatively, the perforations 21 are located on the outer perimeter 17 of the reflector plate 12 so that the outer perimeter 17 of the reflector plate 12 is readily adjustable, while the perforations 21 do not extend to the outer rim 17a. This embodiment, i.e. perforations 21, provides enhanced durability to the reflector plate 12 by minimizing the susceptibly of tearing or damage localized at the outer rim 17a.

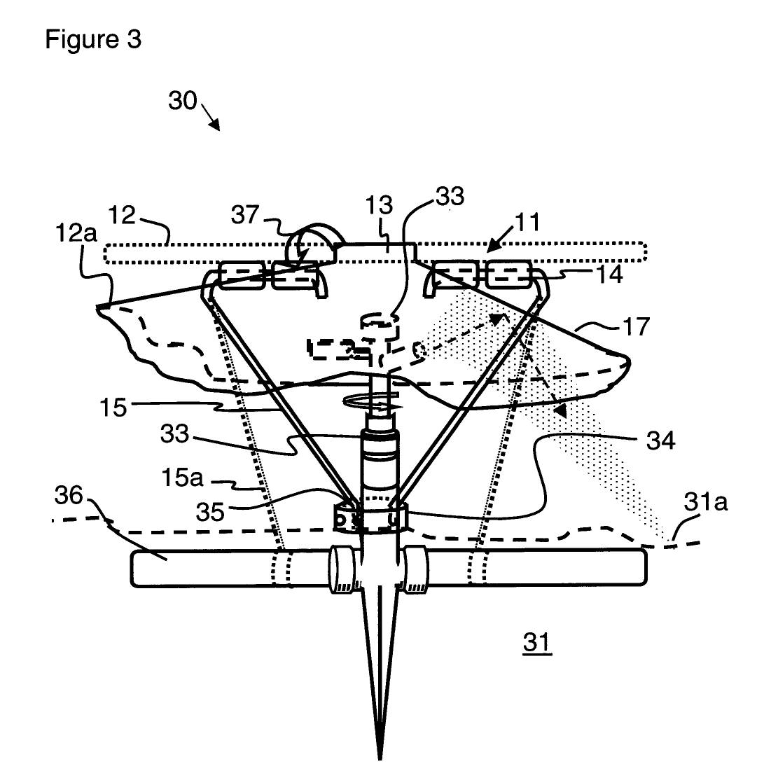

The precision irrigator apparatus 11 and system for watering irregular areas further comprises at least one attachment means 15 appointed to attach the reflector plate 12 to an irrigator. The irrigator, or sprinkler, is not shown in this figure, as the reflector plate 12 may be added to any conventional sprinkler as an after market accessory, or the reflector plate 12 may be attached to the sprinkler during manufacture thereof. Attachment means 15 is shown secured to the interior surface 19 of the reflector plate 12. The attachment means 15 may further comprise a hinge 14 appointed with a rod 22 so that the rod 22 extends from the hinge 14 and pivots within the hinge 14. In addition, the rod 22 of the attachment means 15 further comprises a securing member 16. The securing member 16 is appointed to secure or attach the precision irrigator apparatus 11 to an irrigator, the ground, piping, or any other proximate object. Optionally, the securing member 16 comprises a clamp portion (see FIG. 3) in order to facilitate securing the precision irrigator apparatus 11 to the irrigator, piping associated with the irrigator, or other proximate object. Alternatively, the securing member 16 comprises a hook portion as illustrated in FIG. 1 so that the apparatus 11 can be quickly attached to the irrigator, piping, or a proximate object.

FIG. 2a illustrates a schematic top view of another embodiment of the reflector plate of the precision irrigation apparatus and system wherein the irrigation apparatus is not attached to a sprinkler system, shown generally at 80. A side view of the reflector plate, taken along plane X of the precision irrigation apparatus shown in FIG. 2a is illustrated in FIG. 2b, shown generally at 90. As illustrated in FIGS. 2a and 2b, in this embodiment, the reflector plate 81 is composed of an internal flexible portion 82 and an external flexible covering 83 so that the reflector plate 81 is readily adjustable. The external flexible covering 83 may further comprise a polymeric coating 84. The internal flexible portion 82 may be composed of a flexible wire. Alternatively, the internal flexible portion 82 may be composed of a mesh construction. The external flexible covering 83 may be composed of a silicon material. The external flexible covering 83 and the internal flexible portion 82 function in concert to provide ease to the user in adjusting or contouring the reflector plate 81 so that the reflector plate 81 is readily adjusted and retains its contoured form even under the force of water being reflected therefrom. The reflector plate 81 includes the at least one attachment means 15 appointed to attach the reflector plate 81 to an irrigator.

FIG. 3 illustrates the precision irrigation apparatus attached to an irrigator, shown as a typical impulse sprinkler, and wherein the precision irrigation apparatus's reflector plate is in an adjusted configuration in order to precisely water an irregularly shaped vegetative area, shown generally at 30. The precision irrigator system 30 for watering irregular areas 31 comprises a sprinkler 33 with reflector plate 12 attached thereto by way of at least one attachment means 15. The attachment means 15 is hingedly connected to the reflector plate 12, and 12a, by way of hinge 14 appointed with a rod 22 so that the rod 22 extends from the hinge 14 and pivots within the hinge 14. In addition, the rod 22 of the attachment means 15 further comprises a securing member 16. The securing member 16 is adapted to secure or attach the precision irrigator apparatus 11 to an irrigator, the ground, piping, or any other proximate object. Attachment means 15 is secured to the irrigator 33 by way of the attachment mean's 15 securing member 16, herein shown having a clamp portion 34. As shown, the securing member 15 further comprises flat section 35 that comes into intimate contact with the sprinkler 33 and is clamped thereto by way of clamp portion 34. An alternative securing member 16 is shown in the phantom at 16a wherein the securing member 16a basically includes a clamp or hook that can be received around an object or piping 36, wherein piping 36 herein is shown as underground water piping feeding sprinkler 33.

Continuing with FIG. 3, reflector plate 12 is shown in the phantom. The reflector plate 12 is substantially composed of a malleable material so that the reflector plate 12 is readily adjusted to achieve contours based on the varying area 31 radii from the sprinkler 33. The malleable material provides flexibility to the reflector plate 12 so that the reflector plate 12 can be adjusted or contoured by a user based on the shape of the area 31 to be irrigated. As reflector plate 12 is bent and contoured, the contoured reflector plate 12a is achieved. Such adjustment is generally achieved by bending or contouring the reflector plate 12 based proportionately upon the irregular shape area's 31 dimensions and corresponding radii measurements from the irrigator 33. That is to say, when irregular area 31a is at an increased radii or distance from the sprinkler 33, then the reflector plate 12/12a is to be minimally contoured so that angle 37 from center 13 will minimal; conversely, when the irregular area 31a is a small distance or radii from the sprinkler 33, then the reflector plate 12/12a will be contoured or adjusted so that angle 37 from center 13 increases.

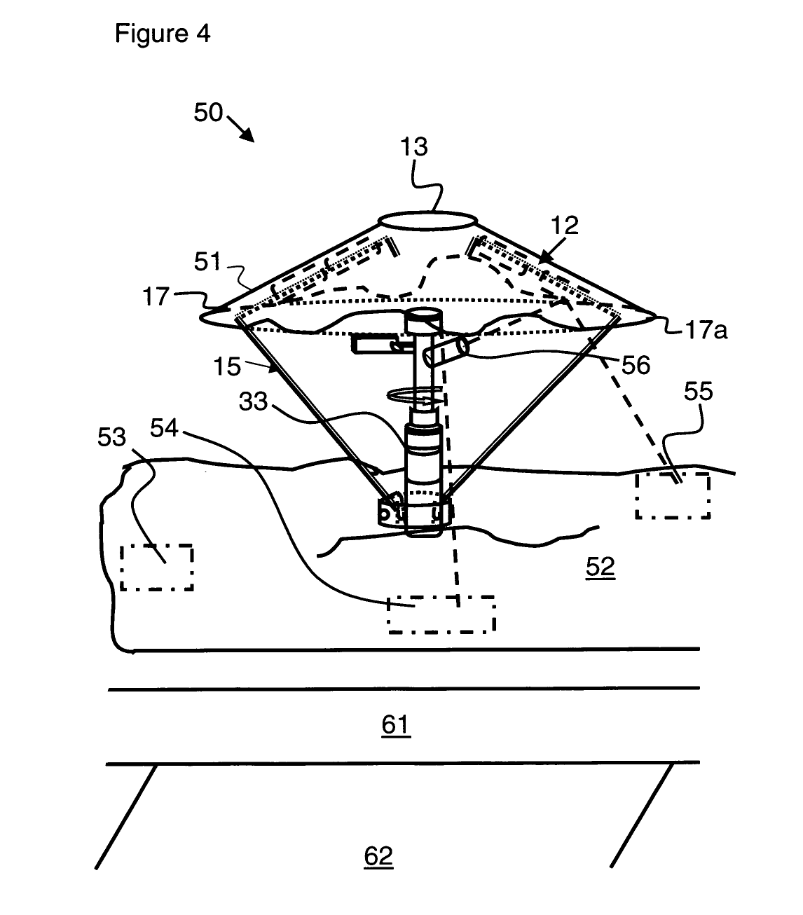

FIG. 4 illustrates the precision irrigation apparatus and system adjusted in configuration in order to precisely water an irregularly shaped vegetative area, shown generally at 50. The reflector plate 12 having center 13 and outer perimeter 17 is attached to sprinkler 33 having a nozzle 56 for delivering water to the irregular vegetative area 52. The reflector plate 12 is contoured to form contoured reflector plate configuration 51. Countering or adjusting of reflector plate 12 to achieve the configuration of contoured reflector plate 51 results as a function of the irregular vegetative area 52, including sections 53, 54, and 55. As the nozzle 56 of sprinkler 33 rotates water is reflected from the outer perimeter 17 and rim of the contoured reflector plate configuration 51. The radius between the sprinkler 33 and each of the sections 53, 54, and 55, operates to determine the contouring feature configured in reflector plate 12 and visa vie contoured reflector plate configuration 51, so that minimal water wastage is delivered to curb 61 and sidewalk 62.

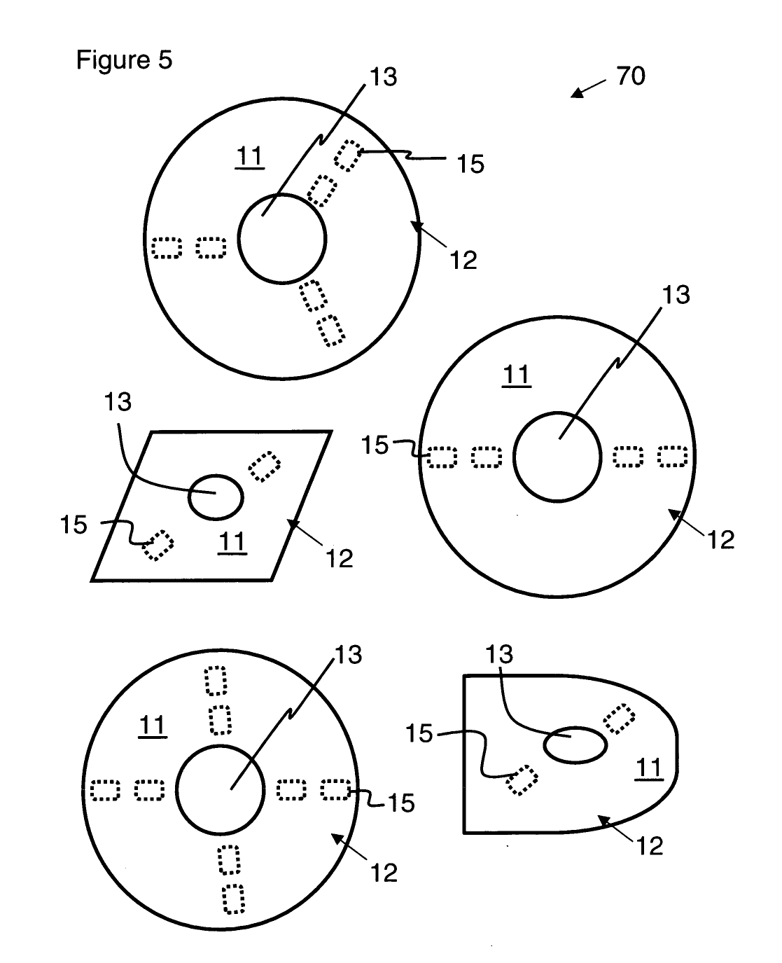

FIG. 5 illustrates schematic views of the reflector plate, showing the plate having various shapes, and further illustrating placement of at least one attachment means, shown generally at 70. For example, the reflector plate 12 may have a circular, parallelogram, or any geometrical shape. When the reflector plate 12 is circular in shape, the reflector plate 12 may have a radii ranging from 7.62 cm (3 inches) to 30.48 cm (12 inches). The reflector plate 12 may have a length ranging from 7.62 cm (3 inches) to 60.96 cm (24 inches). The outer perimeter 17 of the reflector plate 12 may comprise at least one of wall portion having an arced edge, or a flat edge. Attachment means 15 are provided.

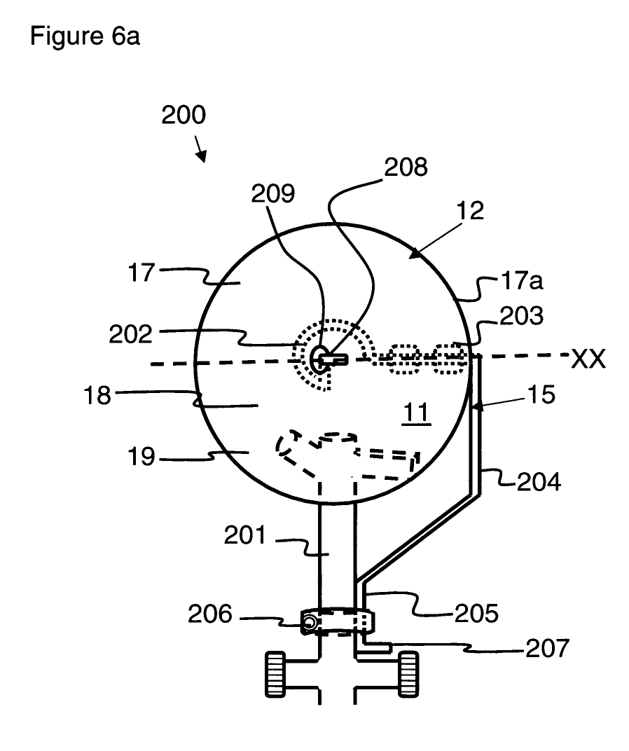

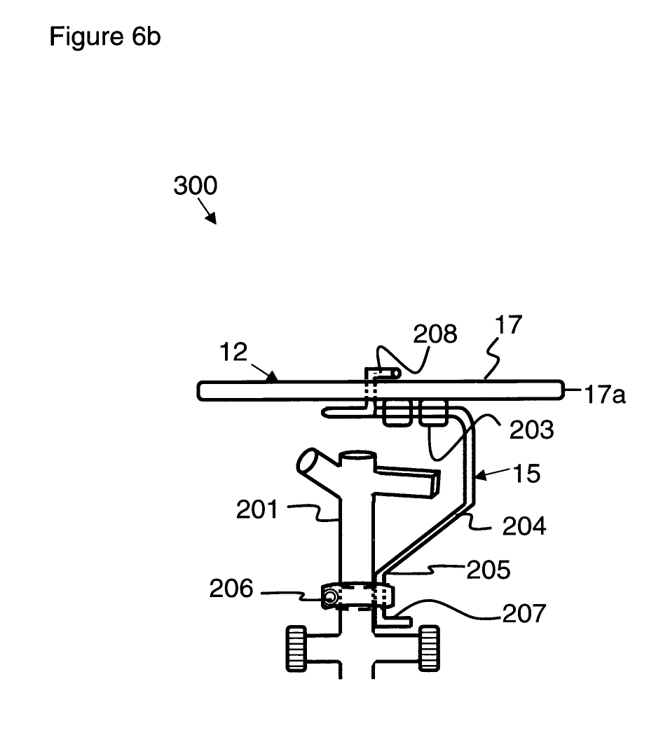

FIG. 6 illustrates a schematic top view of another embodiment of the reflector plate of the precision irrigation apparatus and system, shown generally at 200. A side view of the reflector plate shown in FIG. 6, taken along plane XX, is illustrated in FIG. 6b, shown generally at 300. As illustrated in FIGS. 6a and 6b, in the embodiment shown at 200 and 300 (top and side views, respectively) there is a single attachment means 15. In this embodiment, the precision irrigation apparatus 11 comprises a reflector plate 12 appointed to be attached to an irrigator 201. The reflector plate 12 includes a center aperture 209, an outer perimeter 17, top surface 18 (external), and bottom surface 19 (internal). Outer perimeter 17 includes an outer rim 17a. Optionally, the bottom or internal surface 19 of the reflector plate 12 is coated with a thin film, preferably polymeric in composition. This thin film acts as a buffer in order to decrease the sound levels from advancing to high decibels as the water being forcefully ejected from the sprinkler comes into contact with the reflector plate 12. The precision irrigator apparatus 11 and system for watering irregular areas further comprises at least one attachment means 15 appointed to attach the reflector plate 12 to irrigator 201. In this embodiment, there is a single attachment means 15.

Continuing with FIGS. 6a and 6b, top view at 200 and side view at 300, attachment means 15 is shown secured to the interior surface 19 of the reflector plate 12 by way of unilateral portion 202. Unilateral portion 202 has a three quarter circle configuration and comprises an outer tab 208. Unilateral portion 202 extends through center aperture 209 so that outer tab 208 is on the top external surface 18 of reflector plate 12 in order to enhance stabilization of the reflector plate 12 when attached to a sprinkler 201. On the bottom surface 19 of reflector plate 12, and in the center 13 thereof, the unilateral portion 202 is preferably composed of a steel wire having a three quarter circular winding which facilitates in securing and supporting the reflective plate 12 to the sprinkler 201. This three quarter circle configuration efficiently prevents the reflective plate 12 from tilting to the left or right as water is forced upon the reflective plate 12. Unilateral portion 202 further comprises a hinge pair 203 and a unilateral rod 204. In this embodiment, unilateral rod 204 supports the reflector plate 12 (optionally composed of a thin aluminum disc) on sprinkler 201. The unilateral rod 204 is received in the hinge pair 203 so that the unilateral rod 204 extends from the hinge pair 203 and pivots within the hinge pair 203. In addition, the unilateral rod 204 of the unilateral portion 202 via attachment means 15 further comprises a unilateral securing member 205 appointed to be secured via unilateral bolt attachment 206. Securing member 205 further comprises lower locking member 207 appointed to minimize traveling of the unilateral securing member 205 upwards due to resultant water forces upon the reflector plate 12. Bolt attachment 206 generally includes two straps and two bolts and nuts that act in concert to hold the unilateral rod 204 tightly on the sprinkler 201. Alternatively, the unilateral securing member 205 comprises a hook portion so that the apparatus 11 can be quickly attached to the irrigator, piping, or a proximate object.

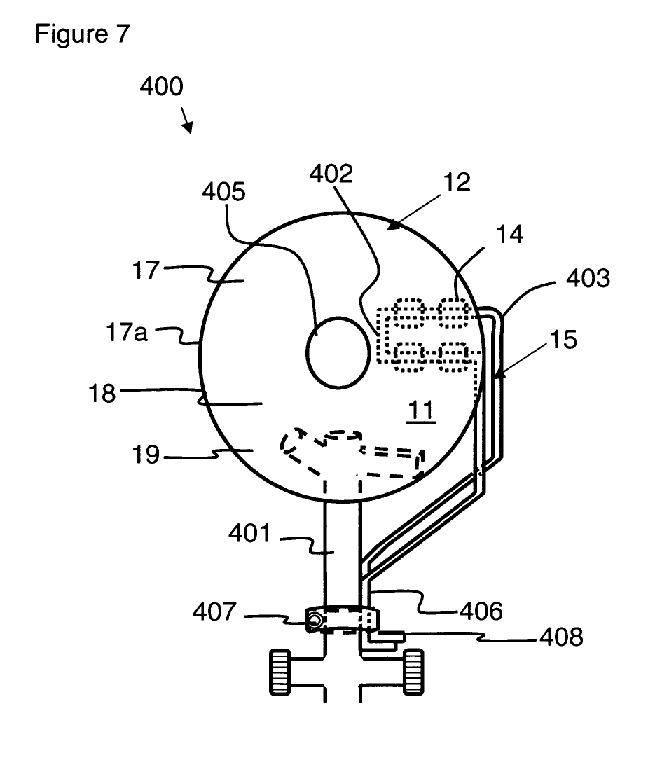

FIG. 7 illustrates a schematic top view of another embodiment of the reflector plate of the precision irrigation apparatus and system, shown generally at 400. The precision irrigator system 400 for watering irregular areas comprises a sprinkler 401 with reflector plate 12 attached thereto by way of at least one attachment means 15. Herein, there are two attachment means 15 located in close proximity to one another. Attachment means 15 are hingedly connected to the reflector plate 12 by way of hinge 14 appointed with a dual rods 403 so that dual rods 403 extend from hinge 14 and pivot within hinge 14. Dual rod 403 of each of attachment means 15 are attached together by way of joiner bar 402, for added stabilization to reflector plate 12 as water is forced up and reflected therefrom. In addition, the dual rods 403 of attachment means 15 further comprise a securing member 16. The reflector plate 12 includes a center aperture 405, an outer perimeter 17, top surface 18 (external), and bottom surface 19 (internal). Outer perimeter 17 includes an outer rim 17a. Optionally, the bottom or internal surface 19 of the reflector plate 12 is coated with a thin film, preferably polymeric in composition. This thin film acts as a buffer in order to decrease the sound levels from advancing to high decibels as the water being forcefully ejected from the sprinkler comes into contact with the reflector plate 12. In this embodiment, dual rods 403 and joiner bar 402 support the reflector plate 12 (optionally composed of a thin aluminum disc) on sprinkler 401.

Continuing with FIG. 7, dual rods 403 of attachment means 15 further comprises dual securing members 406 appointed to be secured via dual bolt attachment 407. Dual securing members 406 further comprise dual lower locking members 408 appointed to minimize traveling of the dual securing member 406 upwards due to resultant water forces upon the reflector plate 12. Bolt attachment 407 generally includes two straps and two bolts and nuts that act in concert to hold the dual rods 403 tightly on the sprinkler 401. Alternatively, the dual securing members 406 comprise hook portions so that the apparatus 400 can be quickly attached to the irrigator, piping, or a proximate object.

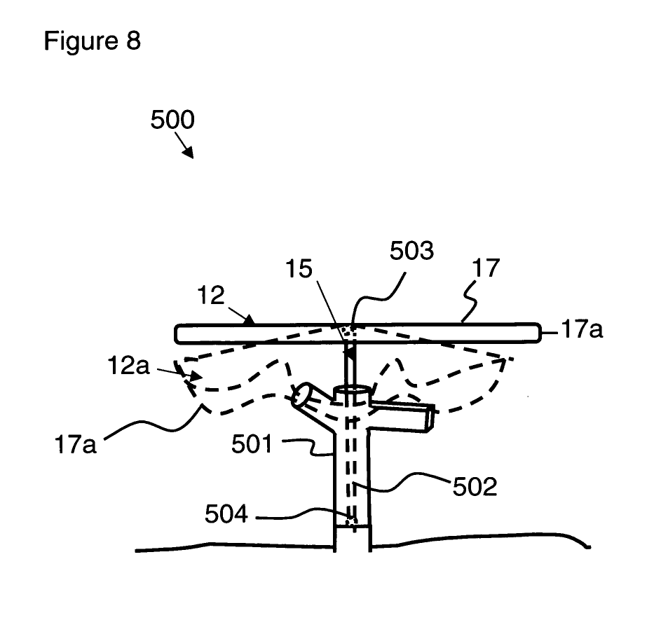

FIG. 8 illustrates a schematic top view of another embodiment of the precision irrigation apparatus and system wherein there is a single attachment means and the apparatus is fixed within a manufactured sprinkler, shown generally at 500. In this embodiment shown at 500, the precision irrigator system 500 for watering irregular areas manufactured as a component within a sprinkler. The manufactured precision irrigator system 500 comprises a precision sprinkler 501 with reflector plate 12 fixedly attached thereto by way of at least one attachment means 15, herein shown as a unilaterally fixed rod 502. Unilaterally fixed rod 502 extends from within sprinkler 501 and remains in a fixed position. As sprinkler 501 rotates or oscillates, unilaterally fixed rod 502 remains still and does not rotate. Unilaterally fixed rod 502 is fixedly connected to the reflector plate 12, and phantom plate 12a which shows adjustment of reflector plate 12, by way of unilateral attachment 503. In addition, unilaterally fixed rod 502 of attachment means 15 further comprises a unilateral securing member 504. The unilateral securing member 504 is adapted to fixedly attach unilaterally fixed rod 502 of the precision irrigator apparatus 500 to irrigator 501. Reflector plate 12 is shown in the phantom at 12a. The reflector plate 12 is substantially composed of a malleable material so that the reflector plate 12 is readily adjusted to achieve contours based on the irregular area. The reflector plate 12 includes an outer perimeter 17 having an outer rim 17a. As reflector plate 12 is bent and contoured, contoured reflector plate 12a is achieved. Such adjustment is generally achieved by bending or contouring the reflector plate 12 based proportionately upon the irregular shape area's dimensions.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A precision irrigator apparatus for watering irregular areas, comprising:
a. a reflector plate composed of a malleable material so that said reflector plate can be adjusted by a user, said reflector plate having a center and having an outer perimeter; and
b. at least one attachment means appointed to attach said reflector plate to an irrigator, said irrigator being appointed to provide water to terrain having said irregular areas;
wherein said reflector plate is attached to said irrigator by way of said attachment means and wherein said reflector plate is adjusted by said user so that said water is delivered to said terrain having said irregular area.

2. A precision irrigator apparatus as recited by claim 1, wherein said reflector plate is composed of an aluminum material.

3. A precision irrigator apparatus as recited by claim 1, wherein said reflector plate further comprises an outer rim having a plurality of perforations so that said reflector plate is readily adjustable.

4. A precision irrigator apparatus as recited by claim 1, wherein said outer perimeter of said reflector plate has a plurality of perforations so that said outer perimeter of said reflector plate is readily adjustable.

5. A precision irrigator apparatus as recited by claim 1, wherein said reflector plate further comprises a top surface and a bottom surface, wherein said bottom surface is coated with a thin film.

6. A precision irrigator apparatus as recited by claim 1, wherein said reflector plate is composed of an internal flexible portion and an external flexible covering so that said reflector plate is readily adjustable.

7. A precision irrigator apparatus as recited by claim 6, wherein said internal flexible portion is composed of a flexible wire.

8. A precision irrigator apparatus as recited by claim 6, wherein said internal flexible portion is composed of a mesh construction.

9. A precision irrigator apparatus as recited by claim 6, wherein said external flexible covering further comprises a flexible polymeric coating.

10. A precision irrigator apparatus as recited by claim 1, wherein said reflector plate has a circular shape.

11. A precision irrigator apparatus as recited by claim 8, wherein said reflector plate has a radii ranging from 7.62 cm (3 inches) to 30.48 cm (12 inches).

12. A precision irrigator apparatus as recited by claim 1, wherein said center of said reflector plate is composed of a rigid material.

13. A precision irrigator apparatus as recited by claim 1, wherein said reflector plate has a length ranging from 7.62 cm (3 inches) to 60.96 cm (24 inches).

14. A precision irrigator apparatus as recited by claim 1, wherein said outer perimeter of said reflector plate comprises wall portions wherein at least one of said wall portions has a flat edge.

15. A precision irrigator apparatus as recited by claim 1, wherein said outer perimeter of said reflector plate comprises wall portions wherein at least one of said wall portions has an arced edge.

16. A precision irrigator apparatus as recited by claim 1, wherein said attachment means further comprises a hinge appointed with a rod so that said rod extends from said hinge and pivots within said hinge, said rod further comprising a securing member.

17. A precision irrigator apparatus as recited by claim 16, wherein said securing member comprises a clamp portion.

18. A precision irrigator apparatus as recited by claim 16, wherein said securing member comprises a hook portion.

19. A precision irrigator apparatus as recited by claim 1, wherein there is a single attachment means comprising a unilateral portion.

20. A precision irrigator apparatus as recited by claim 19, wherein said unilateral portion comprises a steel wire having at least a three quarter circular winding.

21. A precision irrigator apparatus as recited by claim 19, wherein said unilateral portion comprises an outer tab adapted to extend through a center aperture located in said center of said reflector plate.

22. A precision irrigator apparatus as recited by claim 19, wherein said unilateral portion comprises a unilateral rod having a unilateral securing member, said unilateral securing member further comprising a lower locking member adapted to minimize movement of said unilateral securing member due to resultant water forces upon said reflector plate.

23. An irrigator system for watering irregular areas, comprising:
a. a sprinkler;
b. a reflector plate being substantially composed of a malleable material so that said reflector plate can be adjusted by a user, said reflector plate having a center and having an outer perimeter; and
c. said reflector plate being appointed to be attached to said sprinkler, said sprinkler being appointed to provide water to said irregular areas;
wherein said reflector plate is adjusted by said user so that said water is delivered to said irregular area.

24. A method for irrigating irregular areas, comprising the steps of:
a. attaching a reflector plate to an irrigator, said irrigator being appointed to provide water to terrain having said irregular areas, said reflector plate being substantially composed of a malleable material so that said reflector plate can be adjusted by a user, said reflector plate having a center and having an outer perimeter; and
b. adjusting said reflector plate by said user by way of bending said reflector plate;
wherein said reflector plate is attached to said irrigator by way of said attachment means and wherein said reflector plate is adjusted by said user so that said water is delivered to said terrain having said irregular area.
